(19) United States
(12) Patent Application Publication
(10) Pub. No.: US 2026/0320129 A1
(43) Pub. Date: Oct. 15, 2026

(54) DATA PROCESSING METHOD, SYSTEM AND APPARATUS, AND DEVICE AND MEDIUM

(71) Applicant: CLOUD INTELLIGENCE ASSETS HOLDING (SINGAPORE) PRIVATE LIMITED, Singapore (SG)

(72) Inventors: Cen ZHENG, Zhejiang (CN); Bo WEN, Zhejiang (CN); Lunfan XU, Zhejiang (CN)

(21) Appl. No.: 19/484,796

(22) PCT Filed: May 11, 2024
(86) PCT No.: PCT/CN2024/092589

§ 371 Date: Nov. 14, 2025

(30) Foreign Application Priority Data
May 18, 2023 (CN) 202310574685.X

(51) Int. Cl. G06F 16/903; G06N 20/00

(52) U.S. Cl. CPC G06F 16/90335; G06N 20/00

(57) ABSTRACT

Embodiments of the present disclosure provide a data processing method, system, and apparatus, a device, and a medium. The method includes: determining, in response to a data processing request for a target attribute, a target operator of a machine learning model built into a database; determining, based on a timing identifier corresponding to the target attribute, a target time series corresponding to the timing identifier, and a storage node that stores the target time series; and pushing down the target operator to the storage node, so that the storage node executes the data processing request for target timing data in the target time series by using the target operator.

The present disclosure is a national stage of International Application No. PCT/CN 2024/092589, filed on May 11, 2024, which claims priority to Chinese Patent Application No. 202310574685.X, filed with the China National Intellectual Property Administration on May 18, 2023 and entitled “DATA PROCESSING METHOD, SYSTEM, AND APPARATUS, DEVICE, AND MEDIUM”, these applications are incorporated herein by reference in their entireties.

### TECHNICAL FIELD

The present disclosure relates to the field of computer technologies, and in particular, to a data processing method, system, and apparatus, a device, and a medium.

### BACKGROUND

With the development of artificial intelligence technology, machine learning models are used in an increasing number of scenarios to achieve tasks such as related learning and prediction, thereby effectively reducing workload of a worker.

In practical application, during use of data in a database, it is usually necessary to obtain required data from the database. For example, when a corresponding task is performed through a machine learning model, it is necessary to obtain data from the database and then perform a data processing task through the machine learning model. A large amount of data needs to be transmitted during execution of tasks, data processing efficiency is low, and a large quantity of bandwidth and storage resources are consumed.

### SUMMARY

To resolve or alleviate a problem existing in the prior art, embodiments of the present disclosure provide a data processing method, system, and apparatus, a device, and a medium.

According to a first aspect, in an embodiment of the present disclosure, a data processing method is provided, applied to a computing node. The method includes:
determining, in response to a data processing request for a target attribute, a target operator of a machine learning model built into a database;
determining, based on a timing identifier corresponding to the target attribute, a target time series corresponding to the timing identifier, and a storage node that stores the target time series; and
pushing down the target operator to the storage node, so that the storage node executes the data processing request for target timing data in the target time series by using the target operator.

According to a second aspect, in an embodiment of the present disclosure, a data processing method is provided, applied to a storage node. The method includes:
receiving a target operator in a machine learning model pushed down by a computing node for executing a data processing request, where the computing node is configured to determine, based on a timing identifier of a target attribute corresponding to the data processing request, a corresponding target time series and a storage node that stores the target time series;
determining, based on a time series, target timing data for satisfying the data processing request; and
performing data processing for the target timing data by using the target operator, and sending a data processing result to the computing node.

According to a third aspect, in an embodiment of the present disclosure, a data processing apparatus is provided. The apparatus includes:
a first determining module, configured to determine, in response to a data processing request for a target attribute, a target operator of a machine learning model built into a database;
a second determining module, configured to determine, based on a timing identifier corresponding to the target attribute, a target time series corresponding to the timing identifier, and a storage node that stores the target time series; and
a pushdown module, configured to push down the target operator to the storage node, so that the storage node executes the data processing request for target timing data in the target time series by using the target operator.

According to a fourth aspect, in an embodiment of the present disclosure, a data processing system is provided, including:
a computing node, configured to perform the method according to the first aspect; and
a storage node, configured to perform the method according to the second aspect.

According to a fifth aspect, in an embodiment of the present disclosure, an electronic device is provided, including a memory and a processor, where
the memory is configured to store a program; and
the processor is coupled to the memory, and is configured to execute the program stored in the memory, so as to implement the method according to the first aspect, or to implement the method according to the second aspect.

According to a sixth aspect, in an embodiment of the present disclosure, a non-transitory machine-readable storage medium is provided. The non-transitory machine-readable storage medium has executable code stored therein, the executable code, when executed by a processor of an electronic device, causing the processor to perform the method according to the first aspect, or to perform the method according to the second aspect.

In the technical solution provided in the embodiments of the present disclosure, in order to facilitate data management, some databases may store timing data based on a time series. In some database systems, machine learning models are used to satisfy data processing requirements thereof. Therefore, in this solution, based on a data processing request for a target attribute, a target operator of a machine learning model built into a database is sent to a storage node which stores a time series corresponding to the target attribute, without the need to transmit target timing data in the storage node to a computing node, so that an amount of data transmitted between nodes can be effectively reduced, thereby improving computing efficiency. In addition, during processing of the timing data by using the machine learning model, it is only necessary to select a corresponding target operator based on the data processing request and push down the target operator to the corresponding storage node, without the need to transmit excessively complex machine learning models to satisfy the data processing requirements. In addition, target operators in the same machine learning model are respectively pushed down to different storage nodes, and different storage nodes perform corresponding data processing tasks, to achieve parallel processing through a plurality of storage nodes, thereby effectively improving data processing efficiency and data processing capability.

### BRIEF DESCRIPTION OF THE DRAWINGS

To describe the technical solutions in embodiments of the present disclosure or in the prior art more clearly, the accompanying drawings required for describing the embodiments or the prior art are to be briefly described below. Apparently, the accompanying drawings in the following description show some embodiments of the present disclosure, and a person of ordinary skill in the art may still derive other accompanying drawings from the accompanying drawings without creative efforts.

FIG. 1 is a schematic flowchart of a data processing method according to an embodiment of the present disclosure;

FIG. 2 is a schematic flowchart of another data processing method according to an embodiment of the present disclosure;

FIG. 3 is a schematic diagram of a data processing apparatus according to an embodiment of the present disclosure;

FIG. 4 is a schematic diagram of another data processing apparatus according to an embodiment of the present disclosure;

FIG. 5 is a schematic structural diagram of a system according to an embodiment of the present disclosure; and

FIG. 6 is a schematic structural diagram of an electronic device according to an embodiment of the present disclosure.

### DESCRIPTION OF EMBODIMENTS

To enable a person skilled in the art to better understand the solution of the present disclosure, technical solutions in embodiments of the present disclosure are clearly and completely described below with reference to the accompanying drawings in the embodiments of the present disclosure.

Some processes described in the specification, claims, and the foregoing accompanying drawings of the present disclosure include a plurality of operations that appear in a specific order. These operations may be performed out of the order in which they appear herein or may be performed in parallel. Serial numbers such as 101 and 102 of operations are only used to distinguish between different operations. The serial numbers do not represent any execution order. In addition, these processes may include more or fewer operations, and the operations may be performed in sequence or in parallel. It should be noted that the descriptions such as “first” and “second” in this specification are used to distinguish different messages, devices, modules, and the like, and do not represent the order of precedence, nor do they limit “first” and “second” to different types. Moreover, the embodiments described below are merely some embodiments of the present disclosure rather than all of the embodiments. All other embodiments obtained by a person skilled in the art based on the embodiments in the present disclosure without creative efforts shall fall within the scope of protection of the present disclosure.

In an existing database, to achieve a better data processing effect, a machine learning model is used to participate in a data processing task. Two implementations are proposed in the existing solutions. One is that the machine learning model outside the database performs the data processing task, and the other is that the machine learning model built into the database performs the data processing task. Specifically, when the data processing task is performed through the machine learning model outside the database, data needs to be obtained from the database. A larger amount of data that needs to be obtained leads to a large amount of bandwidth to be consumed and lower data processing efficiency, and causes a database system to become more complex. The machine learning model may further be built into the database. Specifically, in a relational database, when data processing needs to be performed based on a time series, data in a time series is flattened into a plurality of rows of data. Since timing data in the time series is scattered, in other words, each timing data in the time series is stored in different storage nodes, the timing data needs to be transmitted to a computing node side to perform the corresponding computing task, and a large amount of bandwidth needs to be consumed during data transmission between nodes.

### Explanation of Terms

Time series (TimeSeries): when an indicator of a data source changes over time, a time series is formed. When storing data, a database clusters and stores the data on the same time series as much as possible to improve access efficiency of timing data in the time series. In addition, compression of the timing data is better supported. In a timing data table, a series of data rows with identical tag columns value constitute a time series.
Operator: it is an operation symbol that performs calculations on data in a database.

The technical solutions implemented in the present disclosure are to be explained below in combination with specific embodiments.

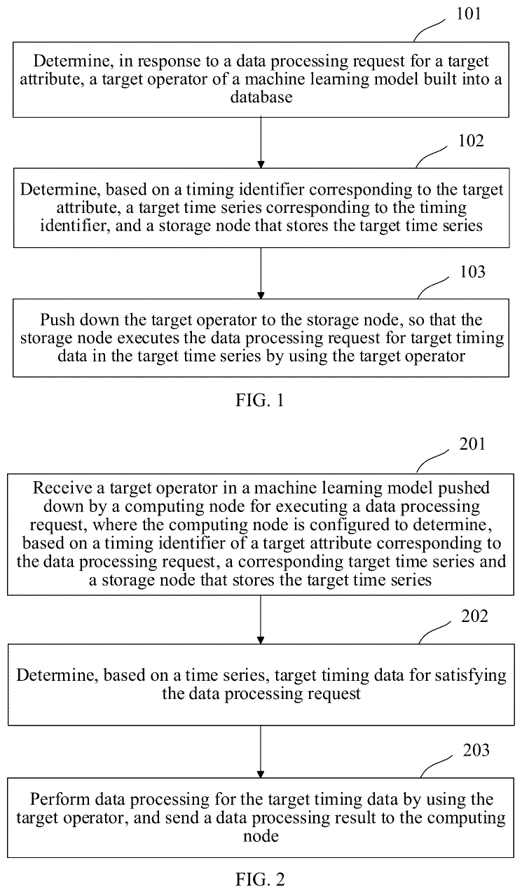

FIG. 1 is a schematic flowchart of a data processing method according to an embodiment of the present disclosure. The method may be performed by a computing node. It may be seen from FIG. 1 that the method specifically includes the following steps.
101: determine, in response to a data processing request for a target attribute, a target operator of a machine learning model built into a database.
102: determine, based on a timing identifier corresponding to the target attribute, a target time series corresponding to the timing identifier, and a storage node that stores the target time series.
103: push down the target operator to the storage node, so that the storage node executes the data processing request for target timing data in the target time series by using the target operator.

It should be noted that in the technical solution of the present disclosure, the data stored in the database is timing data. Specifically, the data in the database is timing data stored based on a time series. The timing data of the same target attribute is often stored in the same time series, and timing data within a continuous period of time in a time series is stored in the same storage node, which facilitates management of the timing data. When a data processing task needs to be performed for a target attribute, it is often not necessary to collect timing data across a plurality of storage nodes.

In the solution of the present disclosure, the machine learning model is built into the database. During use of the machine learning model, the data in the database does not need to be exported to an external platform, which can effectively improve data processing efficiency and ensure security of the data in the database.

The target operators required for the same data processing request with different target attributes are different, the target operators required for different data processing requests with the same target attribute are different, and the target operators required for different data processing requests with different target attributes are different. It should be noted herein that different target attributes may be understood as attributes of different products. The attributes can generate timing-related data. For example, the target attribute may be a customer repurchase ratio of a certain piece of clothing, or a time when peak electricity consumption in a certain area occurs. It may be learned that in practical application, to cause the machine learning model to have a more accurate processing result, different machine learning models need to be trained for different target attributes to satisfy data processing requirements for different target attributes. The different data processing requests mentioned herein may be, for example, a timing prediction request, and may further be a timing anomaly detection request.

In the machine learning model, various different operators are provided. In other words, different target operators are selected for different data processing requirements of different target attributes. For example, an operator required for the timing prediction requests may include that a DeepAR algorithm is a deep neural network algorithm based on a recurrent neural network (RNN), or an attention-based deep neural network (Temporal Fusion Transformer, TFT) algorithm is a deep neural network algorithm based on a transformer mechanism. An operator required for the timing anomaly detection request may include that nsigma has a simple principle and is convenient for analyzing causes of timing data anomalies.

It should be noted herein that in timing data, each time series has a unique timing identifier. Timing data storage refers to combination of a metric and a set of tags as a time series. Under a time series, sampling data at consecutive time points is timing data. Continuous timing data (timestamp, value) is stored under the same time series. During storage, the same time series is stored in the same storage node. Certainly, if the storage node is expanded, the timing data after expansion and the timing data before expansion may be stored in different storage nodes. In this case, it is necessary to determine a specific data processing manner (including: a computing node pushes the target operator to the storage node, or the storage node transmits the timing data to the computing node) to be adopted based on a search of a routing table for distribution of the required timing data in the storage node. The specific selection process is to be described in detail in the following embodiments, and details are not described herein again.

When performing a data processing task, a machine learning model selects target timing data within a certain period of time as required, and determines a storage node where the target timing data is located. In a database system, a computing node simultaneously corresponds to a plurality of storage nodes. When data processing is performed on the timing data by using the target operator, the timing data usually needs to be continuous. Therefore, the target operator is pushed down to a storage node that stores a continuous time series. The completion of the data processing request mentioned herein may involve joint participation of a plurality of different target time series corresponding to the same target attribute. In this case, the same target operator may be sent to the corresponding storage node, and each storage node performs the corresponding data processing task respectively, so that the plurality of storage nodes can perform data processing tasks in parallel. In addition, it is possible that a plurality of different target time series are stored in the same storage node. In this case, the target operator may be sent to the storage node, and the storage node performs data processing tasks on different target time series in sequence, or the storage node performs data processing on the plurality of different target time series in parallel. If the plurality of storage nodes respectively send timing data to computing nodes, due to limited computing power of the computing node, it is necessary to perform data processing tasks in sequence for the timing data provided by each storage node. The efficiency of data processing performed by a single computing node is obviously lower than the efficiency of data processing performed in parallel. It should be noted that in the database system of the solution of the present disclosure, each storage node has certain computing power, which can satisfy a requirement for performing a data processing task by the target operator. A data volume of a data processing result outputted after performing the data processing task is significantly smaller than a data volume of timing data in the time series, thereby effectively reducing the bandwidth consumed by data transmission.

Through the foregoing solution, the machine learning model is built into the database, and when the data processing task is performed, an appropriate target operator in the machine learning model is selected based on the data processing request and the target attribute. In addition, the storage node storing the corresponding time series is determined based on the timing identifier corresponding to the target attribute. Then the target operator is pushed down to the corresponding storage node without the need to transmit the timing data in the storage node to the computing node, which can effectively reduce the pressure of data transmission. In addition, the timing data is processed based on the time series, so that the data processing tasks may be sent to each storage node for parallel execution, which can effectively improve data processing efficiency.

In one or more embodiments of the present disclosure, the determining, based on the timing identifier corresponding to the target attribute, the target time series corresponding to the timing identifier, and the storage node that stores the target time series includes: determining the timing identifier corresponding to the target attribute, and determining a corresponding target time series based on the timing identifier; determining a routing table corresponding to the target time series based on the timing identifier; and determining a storage node corresponding to the target time series and a quantity of storage nodes based on routing information stored in the routing table.

In practical application, when data access is performed, the corresponding storage node is found through the routing table and the data access is performed. Specifically, the corresponding timing identifier and the corresponding target time series are determined based on the target attribute. The routing table corresponding to the target time series is determined through the timing identifier. A storage node corresponding to the time series and a quantity of storage nodes may be learned through a routing path in the routing table. In other words, when the quantity of storage nodes included in the routing table is not one, it may be learned that the timing data corresponding to the time series is dispersedly stored in different storage nodes. When the quantity of storage nodes included in the routing table is one, this indicates that the timing data corresponding to the time series is all stored in the same storage node.

For example, a time series {“metric”: “cpu”, “tags”: “site”: “et2”, “ip”: “1.1.1.1”} is obtained. A combination of the metric and the tag is a time series, and continuous timing data (timestamp, value) is stored under the same time series, for example, timestamp: 12345, value: 1; and timestamp: 12346, value: 2.

Since the timing data in the time series is time-related, when the storage node is expanded, the routing table is to be updated. The storage node corresponding to the time series may be accurately learned through the routing table. Then a corresponding data processing manner is adopted for different storage manners of the time series (stored in the same storage node or stored in a plurality of different storage nodes), so as to maximize the data processing efficiency while satisfying the data processing requirements.

In one or more embodiments of the present disclosure, the pushing down the target operator to the storage node includes: pushing down the target operator to the storage node when it is found that the storage node corresponding to the target time series is a unique node.

In practical application, if it is determined through the routing table that the timing data of the time series is all stored in the same storage node, it indicates that when data processing is performed on the timing data through the machine learning model, the target operator may be pushed down to the corresponding storage node. Then the data processing task can be completed without the need to upload the timing data to the computing node. Since the machine learning model often needs to select continuous data within a period of time when performing data processing for the timing data, the target operator can be pushed down to the storage node and the corresponding data processing task is performed only when the timing data of the time series is in the same storage node. The timing data in the storage node satisfies the requirements of the data processing task without the need to obtain data from other storage nodes. In other words, the corresponding data processing result can be realized within the storage node, thereby avoiding obtaining data from the storage node and reducing consumption of network bandwidth resources caused by data transmission.

In one or more embodiments of the present disclosure, when it is found that the target time series corresponds to a plurality of storage nodes, the target timing data in the plurality of storage nodes corresponding to the same target time series is received.

In practical application, if the storage space is insufficient, the storage node may be expanded, that is, the quantity of storage nodes is increased, which may increase the routing path in the routing table. To be specific, a plurality of storage nodes may be found from the routing table based on the timing identifier. This means that the timing data required by the machine learning model is stored in different storage nodes. If the target operator is sent to the plurality of storage nodes, the data processing requirement cannot be satisfied because each storage node does not store complete timing data. Therefore, the plurality of storage nodes may send the timing data of the same time series to the computing node, and then the computing node performs the data processing task.

For example, a storage node A and a storage node B are provided. In addition, the storage node A stores timing data of a time series A1, and the storage node B stores timing data of a time series B1. It is assumed that a storage space of storage node B is insufficient, a new storage node C needs to be added, and the storage node C is configured to store the timing data of the time series B1. If a data processing request for the time series B1 is received at this time, it is found through the routing table that the time series B1 is stored in the storage node B and the storage node C. In this case, the storage node B and the storage node C may respectively send the timing data corresponding to the time series B1 to the computing node, and the computing node performs the corresponding data processing task.

In one or more embodiments of the present disclosure, the determining, in response to the data processing request for the target attribute, the target operator of the machine learning model built into the database includes:
determining, in response to the data processing request for the target attribute, a target operator type and a target operator required by the data processing request; or determining the target operator based on a function name carried in the data processing request.

In practical application, an operator in the machine learning model may be stored as a database function in a function set of the database. Many types of operators of the machine learning model may be stored in the function set of the database, for example, a timing prediction operator, and a timing anomaly detection operator. In addition, different dedicated machine learning models are adopted for different target attributes, and data used for selection of training samples and training of machine learning models and during data processing is different. Therefore, after the data processing request is received, the target operator type that matches the data processing request type and the target attribute is determined, and then the corresponding target operator is found from the database function based on the target operator type. Certainly, when initiating a data processing request, a user may use a function name to define a specific target operator to be used. When the computing node receives the data processing request, an appropriate target operator can be accurately found based on the function name by parsing the data processing request.

When the data processing request is a comprehensive request involving a plurality of different processing manners, the data processing request needs to be split into tasks. For example, after splitting, two data processing requests are obtained: a prediction request and an anomaly detection request. Since different data processing requests select different target operator types, the corresponding target operator may be selected respectively and sent to the storage node, and the corresponding data processing tasks are performed in sequence. Certainly, if two data processing tasks are associated, then the data processing result of the task executed first may be used as an input of the data processing task to be executed later, so that the data processing task can be performed and completed without data transmission.

In one or more embodiments of the present disclosure, the determining the storage node corresponding to the target time series and the quantity of storage nodes based on the routing information stored in the routing table includes:
determining, based on a time range specified in the data processing request, routing information corresponding to the time range in the routing table; and
determining the storage node corresponding to the target time series and the quantity of storage nodes based on the routing information.

In practical application, when the data processing task of the timing data is performed through the machine learning model, data processing is often performed on continuous timing data therein. Although timing data of some time series is stored in different storage nodes, the timing data required when the machine learning model performs the data processing task may be exactly stored in the same storage node. In other words, timing data does not need to be collected across a plurality of storage nodes. Therefore, the corresponding routing information may be determined based on a time range and routing table (in other words, the routing information includes a time tag range of the timing data and the corresponding storage node information. For example, timing data from time A1 to time A99 is stored in a storage node D1, and timing data corresponding to time B1 to time B99 is stored in a storage node D2), and then a storage node corresponding to the time series required to execute the data processing request and a quantity of storage nodes are determined. When there are multiple storage nodes corresponding to the target time series determined based on the routing information, the multiple storage nodes respectively send the timing data to the computing node, and the computing node performs the corresponding data processing task. When there is one storage node corresponding to the target time series determined based on the routing information, the computing node may then send the corresponding target operator to the storage node, and the storage node performs the corresponding data processing task. It should be noted that this time range may be start and end moments specified by the data processing request, or a specified time length but not limited to the start and end moments.

Certainly, a split time series, a time range of sub-time series split from the same time series, and the corresponding storage node may further be determined based on the routing information stored in the routing table. Then the corresponding data processing result may be obtained through the timing data in different storage nodes.

Through the foregoing solution, since the timing data is time-related, even if the storage node is expanded, it may also be determined, based on an actual analysis result with the specified time range, whether the operator can be pushed down. Although the target time series contained in the routing table corresponds to routing paths of a plurality of different storage nodes, if the timing data in the time range required by the machine learning model is exactly in a certain storage node, the target operator may be pushed down to the storage node, thereby effectively improving data processing efficiency.

In one or more embodiments of the present disclosure, a training manner of the machine learning model includes:
pushing down a target operator in a to-be-trained machine learning model to the storage node; and
training the to-be-trained machine learning model by using the target timing data in a time series stored in the storage node.

In practical application, when the machine learning model is trained, the training may also be performed in the corresponding storage node. Specifically, when the machine learning model needs to be trained, usage of the machine learning model is clarified, and then an operator that satisfies the usage requirement is determined. When the machine learning model is trained, in use of the machine learning model, ideally the target operator needs to be pushed down to the storage node, and the corresponding data processing task is performed by using the timing data in the storage node. Therefore, when the machine learning model is trained, the machine learning model also needs to be trained by using the timing data stored in the storage node. Since a large number of training samples are needed to obtain a more accurate training result, the target operator in the machine learning model is pushed down to the storage node that can provide training samples. The storage node provides historical timing data as the training samples to train the operator of the machine learning model and obtain the target operator. Alternatively, if the training samples corresponding to the same time series are distributed and stored in a plurality of different storage nodes, the plurality of different storage nodes are required to upload the training samples to the computing node respectively, and then the computing node performs the training. Through the foregoing manner, when the training samples of the same time series are in the same storage node, it is possible to train the machine learning model without extracting and transmitting a large number of training samples from the storage node to the computation node, which can effectively reduce usage of network bandwidth by data transmission and improve training efficiency.

In addition, if the training samples provided by a plurality of different time series are in different storage nodes, to-be-trained operators may be respectively sent to different storage nodes to perform corresponding training tasks, thereby achieving parallel training and improving training efficiency.

Through the foregoing manner, it is not necessary to send a large number of training samples (that is, the timing data stored in the storage node) to a training node (for example, a computing node). Instead, a large amount of timing data may be used as training samples in the storage node for training, which can effectively improve the training efficiency. A trained machine learning model or target operator is sent to the computing node.

In one or more embodiments of the present disclosure, the determining, based on the timing identifier corresponding to the target attribute, the target time series corresponding to the timing identifier, and the storage node that stores the target time series includes:
determining, based on a timing identifier corresponding to at least one target attribute, a target time series corresponding to each timing identifier; and
determining a storage node corresponding to each target time series; and
the pushing down the target operator to the storage node includes: pushing down the target operator to each storage node.

In practical application, if the data processing request initiated by the user is for data processing requests of a plurality of different target attributes, it is necessary to determine a corresponding timing identifier based on at least one target attribute respectively, and determine a target time series corresponding to each timing identifier. It should be noted that the target time series corresponding to the timing identifiers may be stored in completely different storage nodes, or may be stored in the same storage node. If the target time series are stored in different storage nodes, the computing node may push down the corresponding target operator to the corresponding storage node respectively. If the target time series are stored in the same storage node, due to limited computing power of the storage node, it may be necessary to perform data processing tasks in batches, that is, to send the same or different target operators in batches to the same storage node to perform the data processing tasks. Certainly, the computing node and the storage node may respectively perform data processing tasks for different target attributes. For example, time series respectively corresponding to a target attribute 1 and a target attribute 2 are both stored in the same storage node. It is found through comparison that a data volume of timing data corresponding to the target attribute 1 is smaller than a data volume of timing data corresponding to the target attribute 2. Therefore, the target operator corresponding to the target attribute 2 may be pushed down to the storage node, and the storage node transmits the timing data corresponding to the target attribute 1 to the computing node. Therefore, the usage of the network bandwidth resources by data transmission can be minimized while satisfying a requirement of parallel computing and improving data processing efficiency.

In one or more embodiments of the present disclosure, a timing prediction result or an anomaly detection result fed back by at least one storage node based on the data processing request is received.

In practical application, based on a type of data processing request, the corresponding processing result is fed back. The processing result herein may be the timing prediction result, or may be the anomaly detection result. When the storage node sends the data processing result to the computing node, an amount of data that needs to be sent is much smaller than a data volume of timing data involved in data processing, which can further reduce a data transmission volume while satisfying the data processing requirement. It should be noted that the data processing manner is not limited to the timing prediction result or the anomaly detection result mentioned above. The data processing request may further be timing data analysis, or the like, and the corresponding feedback result is a corresponding result such as a timing analysis result.

Based on the same idea, an embodiment of the present disclosure further provides a data processing method. FIG. 2 is a schematic flowchart of another data processing method according to an embodiment of the present disclosure. The method is applied to a storage node. It may be seen from FIG. 2 that the method specifically includes the following steps.
201: receive a target operator in a machine learning model pushed down by a computing node for executing a data processing request, where the computing node is configured to determine, based on a timing identifier of a target attribute corresponding to the data processing request, a corresponding target time series and a storage node that stores the target time series.
202: determine, based on a time series, target timing data for satisfying the data processing request.
203: perform data processing for the target timing data by using the target operator, and send a data processing result to the computing node.

In practical application, one computing node corresponds to a plurality of storage nodes. The machine learning model is built into a database. Timing data stored in the database is stored based on a time series. Generally speaking, the timing data in the same time series is stored in the same storage node. When a data processing task needs to be performed through the machine learning model, a corresponding time series and a storage node that stores the time series are determined based on the data processing request, and the target operator that can execute the data processing request is pushed down to the corresponding storage node to perform the corresponding data processing task. Through the foregoing manner, a large amount of data is prevented from being sent from the storage node to the computing node while satisfying the data processing request, thereby reducing usage of network bandwidth by data transmission. In addition, an operator configured to perform the data processing task in the machine learning model is sent to the storage node in a targeted manner, which can effectively improve data processing efficiency. In addition, if the operator is sent to a plurality of storage nodes, the plurality of storage nodes may perform the data processing tasks in parallel, which has higher data processing efficiency than that of performing a plurality of data processing tasks only by the computing node.

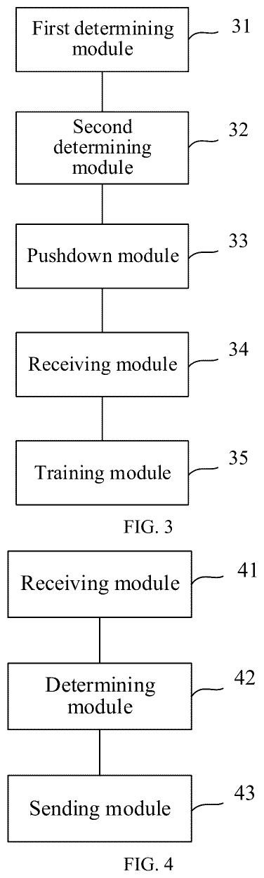

Based on the same idea, an embodiment of the present disclosure further provides a data processing apparatus. FIG. 3 is a schematic diagram of a data processing apparatus according to an embodiment of the present disclosure. It may be seen from FIG. 3 that the apparatus includes:
a first determining module 31, configured to determine, in response to a data processing request for a target attribute, a target operator of a machine learning model built into a database;
a second determining module 32, configured to determine, based on a timing identifier corresponding to the target attribute, a target time series corresponding to the timing identifier, and a storage node that stores the target time series; and
a pushdown module 33, configured to push down the target operator to the storage node, so that the storage node executes the data processing request for target timing data in the target time series by using the target operator.

In an embodiment, the second determining module 32 is configured to: determine the timing identifier corresponding to the target attribute, and determine a corresponding target time series based on the timing identifier;
determine a routing table corresponding to the target time series based on the timing identifier; and
determine a storage node corresponding to the target time series and a quantity of storage nodes based on routing information stored in the routing table.

In an embodiment, the pushdown module 33 is configured to push down the target operator to the storage node when it is found that the storage node corresponding to the target time series is a unique node.

In an embodiment, the apparatus further includes a receiving module 34, configured to receive, when it is found that the target time series corresponds to a plurality of storage nodes, the target timing data in the plurality of storage nodes corresponding to a same target time series.

In an embodiment, the first determining module 31 is configured to: determine, in response to the data processing request for the target attribute, a target operator type and a target operator required by the data processing request; or determine the target operator based on a function name carried in the data processing request.

In an embodiment, the second determining module 32 is configured to: determine, based on a time range specified in the data processing request, routing information corresponding to the time range in the routing table; and
determine the storage node corresponding to the target time series and the quantity of storage nodes based on the routing information.

In an embodiment, the apparatus further includes a training module 35, configured to: push down a target operator in a to-be-trained machine learning model to the storage node; and
train the to-be-trained machine learning model by using the target timing data in a time series stored in the storage node.

The second determining module 32 is configured to determine, based on a timing identifier corresponding to at least one target attribute, a target time series corresponding to each timing identifier; and determine a storage node corresponding to each target time series.

In an embodiment, the second determining module 32 is configured to: push down the target operator to each storage node.

In an embodiment, the receiving module 34 is configured to receive a timing prediction result or an anomaly detection result fed back by at least one storage node based on the data processing request.

Based on the same idea, an embodiment of the present disclosure further provides another data processing apparatus. FIG. 4 is a schematic diagram of another data processing apparatus according to an embodiment of the present disclosure. It may be seen from FIG. 4 that the apparatus includes:
a receiving module 41, configured to receive a target operator in a machine learning model pushed down by a computing node for executing a data processing request, where the computing node is configured to determine, based on a timing identifier of a target attribute corresponding to the data processing request, a corresponding target time series and a storage node that stores the target time series;
a determining module 42, configured to determine, based on a time series, target timing data for satisfying the data processing request; and
a sending module 43, configured to perform data processing for the target timing data by using the target operator, and send a data processing result to the computing node.

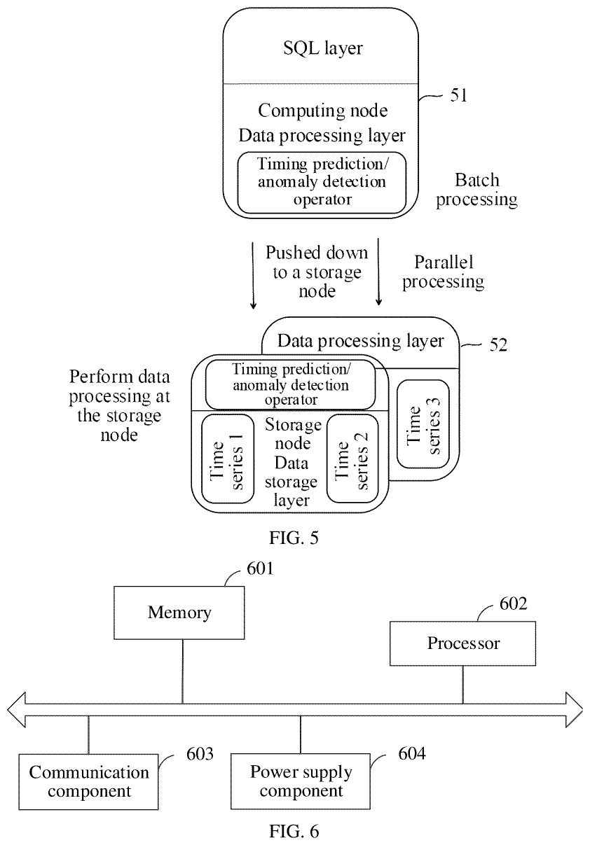

Based on the same idea, an embodiment of the present disclosure further provides a data processing system. FIG. 5 is a schematic structural diagram of a system according to an embodiment of the present disclosure. It may be seen from FIG. 5 that the system includes:
a computing node 51, where the computing node 51 corresponds to at least one storage node 52. The computing node 51 may be divided into two functional layers, which are respectively an SQL layer for supporting SQL language provided by a user and a data processing layer for performing a data processing task. The data processing layer has a built-in operator (for example, a timing prediction operator or an anomaly detection operator) related to a machine learning model. The storage node 52 may be divided into a data processing layer and a data storage layer based on functions. The data processing layer has a built-in pushed-down target operator (for example, a timing prediction operator or an anomaly detection operator), and the data storage layer stores timing data based on a time series. For example, it may be seen from FIG. 5 that a time series 1 and a time series 2 are stored in a storage node 1,and a time series 3 is stored in a storage node 2.

For example, it is assumed that the data processing request is timing prediction or anomaly detection. The data processing layer is mainly responsible for accessing and processing timing data, which has a capability of pulling data from the data storage layer based on a time series dimension and perform some time series-related processing (such as downsampling and some aggregation calculations), and supports expansion of processing operators for the time series dimension. The data processing layer exists in both the computing node and the storage node. Therefore, timing engines of some existing databases may push some timing data processing operators from the computing node to the storage node when conditions permit. On the one hand, a plurality of storage nodes may be used to achieve parallel computing optimization, and on the other hand, optimization close to data calculation can be achieved, thereby reducing data transmitted between nodes and improving computing efficiency.

The timing prediction and the timing anomaly detection are both algorithms for processing data in the time series dimension. The timing prediction is to predict a continuous window in the future based on data of a historical window on the time series. During the timing anomaly detection, newly generated data also needs to be detected based on the historical data of the time series. During implementation, data is usually processed in batches based on the time series dimension to improve detection efficiency.

This solution supports the reasoning function of the timing prediction/anomaly detection algorithm based on machine learning. On the one hand, batch processing optimization can be achieved through a characteristic of the timing engine for the time series dimension processing. On the other hand, the prediction/anomaly detection algorithm may be pushed down to the storage node through the data processing push-down capability of the timing engine, thereby achieving parallel and close-to-data reasoning optimization.

An embodiment of the present disclosure further provides an electronic device. The electronic device is an electronic device as a master node in a computing unit. FIG. 6 is a schematic structural diagram of an electronic device according to an embodiment of the present disclosure. The electronic device includes a memory 601, a processor 602, and a communication component 603.

The memory 601 is configured to store a program.

The processor 602 is coupled to the memory and is configured to execute the program stored in the memory to:
determine, in response to a data processing request for a target attribute, a target operator of a machine learning model built into a database;
determine, based on a timing identifier corresponding to the target attribute, a target time series corresponding to the timing identifier, and a storage node that stores the target time series; and
push down the target operator to the storage node, so that the storage node executes the data processing request for target timing data in the target time series by using the target operator.

The processor 602 is configured to: determine the timing identifier corresponding to the target attribute, and determine a corresponding target time series based on the timing identifier;
determine a routing table corresponding to the target time series based on the timing identifier; and
determine a storage node corresponding to the target time series and a quantity of storage nodes based on routing information stored in the routing table.

The processor 602 is configured to push down the target operator to the storage node when it is found that the storage node corresponding to the target time series is a unique node.

The processor 602 is configured to receive, when it is found that the target time series corresponds to a plurality of storage nodes, the target timing data in the plurality of storage nodes corresponding to a same target time series.

The processor 602 is configured to: determine, in response to the data processing request for the target attribute, a target operator type and a target operator required by the data processing request; or
determine the target operator based on a function name carried in the data processing request.

The processor 602 is configured to determine, based on a time range specified in the data processing request, routing information corresponding to the time range in the routing table; and
determine the storage node corresponding to the target time series and the quantity of storage nodes based on the routing information.

The processor 602 is configured to push down a target operator in a to-be-trained machine learning model to the storage node; and
train the to-be-trained machine learning model by using the target timing data in a time series stored in the storage node.

The processor 602 is configured to determine, based on a timing identifier corresponding to at least one target attribute, a target time series corresponding to each timing identifier; and
determine a storage node corresponding to each target time series.

The processor 602 is configured to: push down the target operator to each storage node.

The processor 602 is configured to receive a timing prediction result or an anomaly detection result fed back by at least one storage node based on the data processing request.

The processor 602 is configured to: receive a target operator in a machine learning model pushed down by a computing node for executing a data processing request, where the computing node is configured to determine, based on a timing identifier of a target attribute corresponding to the data processing request, a corresponding target time series and a storage node that stores the target time series;
determine, based on a time series, target timing data for satisfying the data processing request; and
perform data processing for the target timing data by using the target operator, and send a data processing result to the computing node.

The memory 601 may be configured to store various other data to support operations on the electronic device. Examples of such data include an instruction for operating any application program or method on the electronic device. The memory may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or an optical disc.

Further, the processor 602 in this embodiment may specifically be: a programmable switching processing chip. The programmable switching processing chip is equipped with a data duplication engine, which can duplicate received data.

The foregoing processor 602 may further implement other functions in addition to the foregoing functions when executing the program in the memory. For details, reference may be made to the descriptions of the foregoing embodiments. Further, as shown in FIG. 6, the electronic device further includes another component such as a power supply component 604.

An embodiment of the present disclosure further provides a non-transitory machine-readable storage medium. The non-transitory machine-readable storage medium has executable code stored therein, the executable code, when executed by a processor of an electronic device, causing the processor to perform the method in the corresponding embodiment of FIG. 1 or FIG. 2.

Based on the foregoing embodiments, to facilitate data management, some databases may store timing data based on a time series. In some database systems, machine learning models are used to satisfy data processing requirements thereof. Therefore, in this solution, based on a data processing request for a target attribute, a target operator of a machine learning model built into a database is sent to a storage node which stores a time series corresponding to the target attribute, without the need to transmit target timing data in the storage node to a computing node, so that an amount of data transmitted between nodes can be effectively reduced, thereby improving computing efficiency. In addition, during processing of the timing data by using the machine learning model, it is only necessary to select a corresponding target operator based on the data processing request and push down the target operator to the corresponding storage node, without the need to transmit excessively complex machine learning models to satisfy the data processing requirements. In addition, target operators in the same machine learning model are respectively pushed down to different storage nodes, and different storage nodes perform corresponding data processing tasks, to achieve parallel processing through a plurality of storage nodes, thereby effectively improving data processing efficiency and data processing capability.

User information (including but not limited to user equipment information, user personal information, and the like) and data (including but not limited to data for analysis, stored data, displayed data, and the like) involved in the present disclosure are all authorized by the user or information and data fully authorized by all parties. The collection, use, and processing of relevant data need to conform to relevant laws, regulations, and standards of relevant countries and regions, and provide corresponding operation portals for the user to choose to authorize or refuse.

The apparatus embodiments described above are merely examples. The units described as separate components may or may not be physically separate, and the components displayed as units may or may not be physical units, which may be located in one place, or may be distributed on a plurality of network units. Some or all of the modules may be selected according to actual needs to achieve the objectives of the solutions of the embodiments. A person of ordinary skill in the art may understand and implement the embodiments without creative efforts.

Through the description of the foregoing implementations, a person skilled in the art can clearly understand that the implementations can be implemented by software and necessary general hardware platforms. Definitely, the implementations can also be implemented by hardware. Based on such understanding, the foregoing technical solutions substantially, or a part making a contribution to the prior art may be embodied in the form of a software product. The computer software product may be stored in a computer-readable storage medium such as a ROM/RAM, a magnetic disk, or an optical disk, which includes several instructions to enable a computer device (which may be a personal computer, a server, a network device, or the like) to perform the method in each embodiment or some parts of the embodiments.

Finally, it should be noted that the foregoing embodiments are only used to describe the technical solutions of the present disclosure, but not intended to limit the present disclosure. Although the present disclosure has been described in detail with reference to the foregoing embodiments, it should be understood by a person skilled in the art that the technical solutions described in the foregoing embodiments can still be modified, or some technical features can be replaced by equivalents. However, these modifications or substitutions do not cause the essence of corresponding technical solutions to depart from the spirit and scope of the technical solutions in the embodiments of the present disclosure.

1. A data processing method, applied to a computing node, the method comprises:
determining, in response to a data processing request for a target attribute, a target operator of a machine learning model built into a database;
determining, based on a timing identifier corresponding to the target attribute, a target time series corresponding to the timing identifier, and a storage node that stores the target time series; and
pushing down the target operator to the storage node, so that the storage node executes the data processing request for target timing data in the target time series by using the target operator.

2. The method according to claim 1, wherein the determining, based on the timing identifier corresponding to the target attribute, the target time series corresponding to the timing identifier, and the storage node that stores the target time series comprises:
determining the timing identifier corresponding to the target attribute, and determining a corresponding target time series based on the timing identifier;
determining a routing table corresponding to the target time series based on the timing identifier; and
determining a storage node corresponding to the target time series and a quantity of storage nodes based on routing information stored in the routing table.

3. The method according to claim 2, wherein the pushing down the target operator to the storage node comprises:
pushing down the target operator to the storage node when it is found that the storage node corresponding to the target time series is a unique node.

4. The method according to claim 2, further comprising:
receiving, when it is found that the target time series corresponds to a plurality of storage nodes, the target timing data in the plurality of storage nodes corresponding to a same target time series.

5. The method according to claim 1, wherein the determining, in response to the data processing request for the target attribute, the target operator of the machine learning model built into the database comprises:
determining, in response to the data processing request for the target attribute, a target operator type and a target operator required by the data processing request; or
determining the target operator based on a function name carried in the data processing request.

6. The method according to claim 2, wherein the determining the storage node corresponding to the target time series and the quantity of storage nodes based on the routing information stored in the routing table comprises:
determining, based on a time range specified in the data processing request, routing information corresponding to the time range in the routing table; and
determining the storage node corresponding to the target time series and the quantity of storage nodes based on the routing information.

7. The method according to claim 1, wherein a training manner of the machine learning model comprises:
pushing down a target operator in a to-be-trained machine learning model to the storage node; and
training the to-be-trained machine learning model by using the target timing data in a time series stored in the storage node.

8. The method according to claim 1, wherein the determining, based on the timing identifier corresponding to the target attribute, the target time series corresponding to the timing identifier, and the storage node that stores the target time series comprises:
determining, based on a timing identifier corresponding to at least one target attribute, a target time series corresponding to each timing identifier; and
determining a storage node corresponding to each target time series; and
the pushing down the target operator to the storage node comprises: pushing down the target operator to each storage node.

9. The method according to claim 1, further comprising:
receiving a timing prediction result or an anomaly detection result fed back by at least one storage node based on the data processing request.

10. A data processing method, applied to a storage node, the method comprises:
receiving a target operator in a machine learning model pushed down by a computing node for executing a data processing request, wherein the computing node is configured to determine, based on a timing identifier of a target attribute corresponding to the data processing request, a corresponding target time series and a storage node that stores the target time series;
determining, based on a time series, target timing data for satisfying the data processing request; and
performing data processing for the target timing data by using the target operator, and sending a data processing result to the computing node.

11. (canceled)

12. A data processing system, comprising:
a computing node, configured to perform the method according to claim 1; and
a storage node, configured to:
receive a target operator in a machine learning model pushed down by a computing node for executing a data processing request, wherein the computing node is configured to determine, based on a timing identifier of a target attribute corresponding to the data processing request, a corresponding target time series and a storage node that stores the target time series;
determine, based on a time series, target timing data for satisfying the data processing request; and
perform data processing for the target timing data by using the target operator, and send a data processing result to the computing node.

13. An electronic device, comprising a memory and a processor, wherein
the memory is configured to store a program; and
the processor is coupled to the memory, and is configured to execute the program stored in the memory, so as to:
determine, in response to a data processing request for a target attribute, a target operator of a machine learning model built into a database;
determine, based on a timing identifier corresponding to the target attribute, a target time series corresponding to the timing identifier, and a storage node that stores the target time series; and
push down the target operator to the storage node, so that the storage node executes the data processing request for target timing data in the target time series by using the target operator.

14. A non-transitory machine-readable storage medium, having executable code stored therein, the executable code, when executed by a processor of an electronic device, causing the processor to perform the method according to claim 1.

15. A non-transitory machine-readable storage medium, having executable code stored therein, the executable code, when executed by a processor of an electronic device, causing the processor to perform the method according to claim 10.

16. The electronic device according to claim 13, the processor is further configured to execute the program stored in the memory, so as to:
determine the timing identifier corresponding to the target attribute, and determine a corresponding target time series based on the timing identifier;
determine a routing table corresponding to the target time series based on the timing identifier; and
determine a storage node corresponding to the target time series and a quantity of storage nodes based on routing information stored in the routing table.

17. The electronic device according to claim 16, the processor is further configured to execute the program stored in the memory, so as to:
push down the target operator to the storage node when it is found that the storage node corresponding to the target time series is a unique node.

18. The electronic device according to claim 16, the processor is further configured to execute the program stored in the memory, so as to:
receive, when it is found that the target time series corresponds to a plurality of storage nodes, the target timing data in the plurality of storage nodes corresponding to a same target time series.

19. The electronic device according to claim 13, the processor is further configured to execute the program stored in the memory, so as to:
determine, in response to the data processing request for the target attribute, a target operator type and a target operator required by the data processing request; or
determine the target operator based on a function name carried in the data processing request.

20. The electronic device according to claim 16, the processor is further configured to execute the program stored in the memory, so as to:
determine, based on a time range specified in the data processing request, routing information corresponding to the time range in the routing table; and
determine the storage node corresponding to the target time series and the quantity of storage nodes based on the routing information.

21. An electronic device, comprising a memory and a processor, wherein
the memory is configured to store a program; and
the processor is coupled to the memory, and is configured to execute the program stored in the memory, so as to implement the method according to claim 10.
